(19) United States
(12) Patent Application Publication
(10) Pub. No.: US 2014/0168981 A1
(43) Pub. Date: Jun. 19, 2014

(54) Cover Assembly

(71) Applicant: Molex Incorporated, Lisle, IL (US)

(72) Inventors: Nico VanStiphout, Beek en Donk (NL); Daniel B. McGowan, Lisle, IL (US); Carlos Carranza, Lake Forest, CA (US)

(73) Assignee: Molex Incorporated, Lisle, IL (US)

(21) Appl. No.: 14/109,931

(22) Filed: Dec. 17, 2013

Related U.S. Application Data
(60) Provisional application No. 61/738,159, filed on Dec. 17, 2012.

(51) Int. Cl. F21K 99/00; H01R 13/46

(52) U.S. Cl. CPC F21K 9/30; H01R 13/46
USPC 362/249.02; 439/620.02

(57) ABSTRACT

A cover assembly includes a bottom surface that supports deflecting terminals and a connector and further includes a controller mounted on the bottom surface that receives power from the connector and directs the power to the deflecting terminals. Traces formed on the bottom surface can electrically couple the connector to the controller and the controller to the deflecting terminals.

### RELATED APPLICATIONS

This application claims priority to U.S. Provisional Application No. 61/738,159, filed Dec. 17, 2013, which is incorporated herein by reference in its entirety.

### FIELD OF THE INVENTION

The present invention relates to the field of light emitting diode (LED) illumination.

### DESCRIPTION OF RELATED ART

LEDs are known for their ability to provide general illumination. Recent advances have made LEDs increasing cost effective and efficient and it is likely that LEDs will soon become the primary illumination source. While LED performance properties have continued to improve, it is sometimes still challenging to use the LEDs in certain applications. For certain applications improved systems of powering and supporting LEDs would be appreciated.

Holders are sometime used to secure LEDs into position. A holder can help secure an LED array into place, however, existing holders does not always provide all the functionality needed and therefore certain individuals would appreciated further improvements in holders.

### BRIEF SUMMARY

A holder includes a power connector and terminals that are configured to engage contacts on a top surface of an LED array. Traces on the underside of the holder can be used to electrically connect the power connector to the terminals. If desired, integrated circuitry can be provided on an underside of the cover to help control the LED functionality. The holder can thus provide a cover in addition to a holder function while also supporting additional functionality.

### BRIEF DESCRIPTION OF THE DRAWINGS

The present invention is illustrated by way of example and not limited in the accompanying figures in which like reference numerals indicate similar elements and in which:

FIG. 1 illustrates a perspective view of an embodiment of a cover and LED assembly.

FIG. 2 illustrates another perspective view of the embodiment depicted in FIG. 1.

FIG. 3 illustrates a perspective bottom view of an embodiment of a cover.

FIG. 4 illustrates another perspective view of the embodiment depicted in FIG. 3.

FIG. 5 illustrates a bottom view of the embodiment depicted in FIG. 3.

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

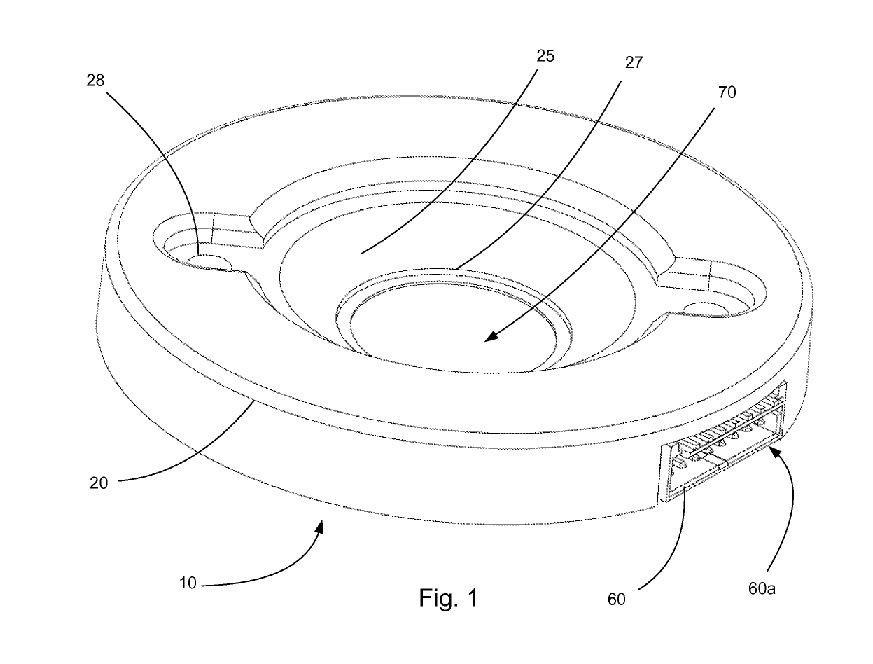

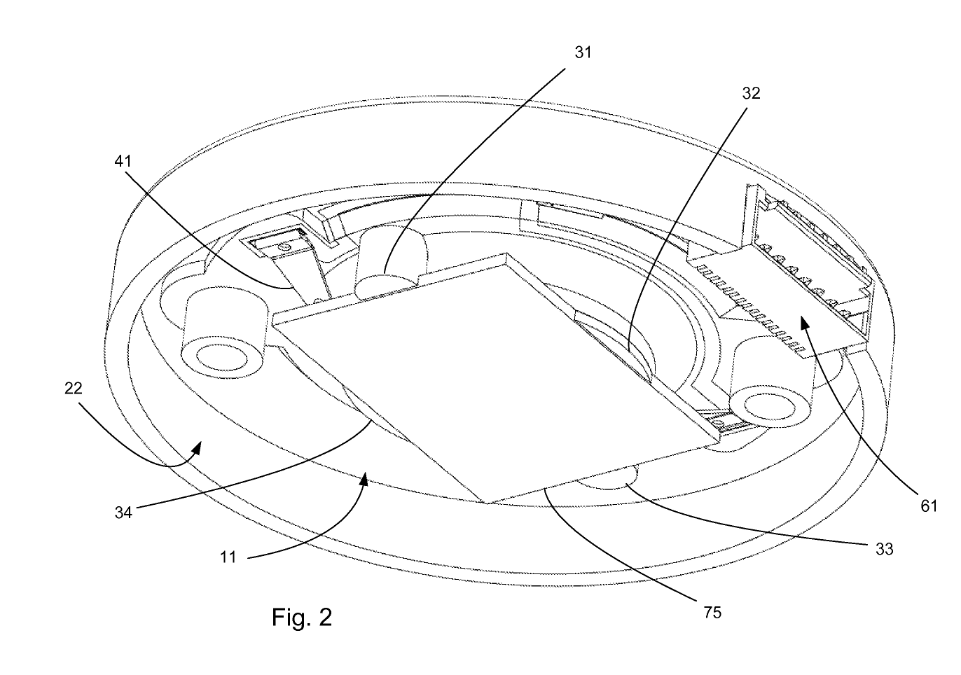

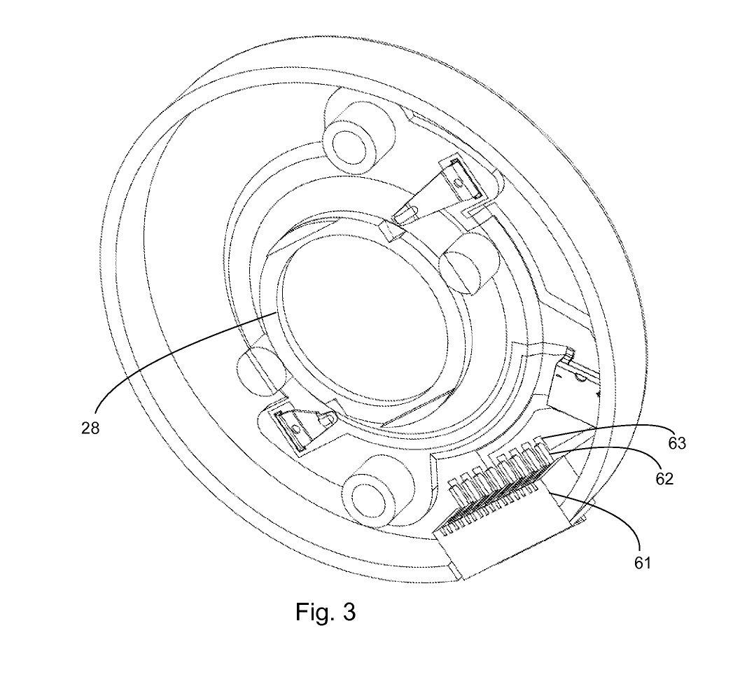

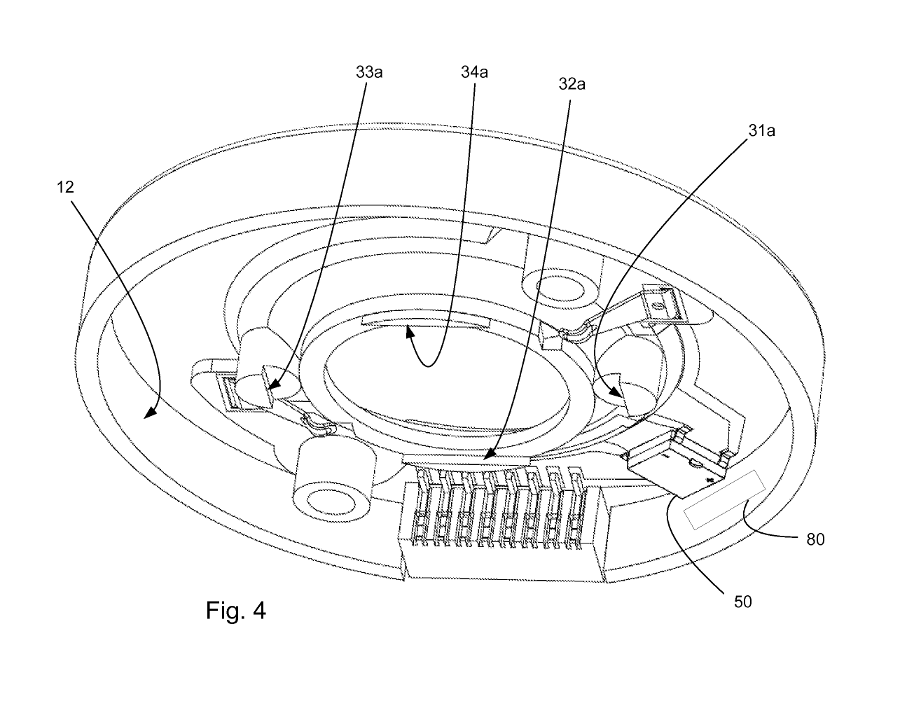

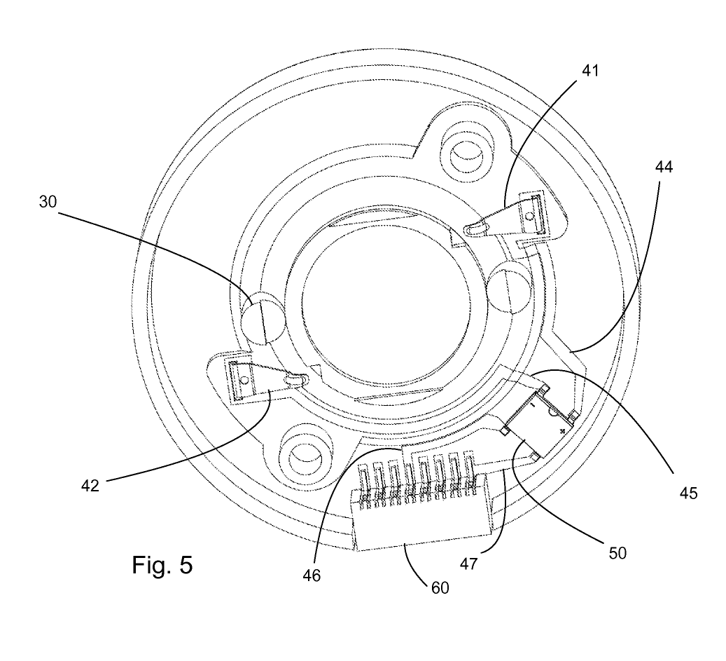

FIGS. 1-5 illustrate features of a cover 10 with a light aperture 27 that allows light to pass through the cover 10. The cover 10 includes one or more retaining members 30 (such as peg 31, shoulder 32, peg 33 and shoulder 34) that help locate and position an LED array 70 respectively via surfaces 31a, 32a 33a and 34a.

The LED array 70 can be configured as a chip on board (COB) style LED array. The LED array 70 can include one or more LEDs in pattern and the LEDs will be electrically connected to an anode and a cathode. Deflecting terminals 41, 42 are supported by the cover and are configured to deflect when they engage the anode and cathode contacts on the LED array 70 and thus can provide power to the LED array 70.

A controller 50 is mounted on a bottom surface 11 of the cover 10 and the controller 50 may include a bridge rectifier and other control circuitry such as amplifiers and communication functionality, receives input power and provides power to the corresponding LED array. Naturally, additional circuitry can be added as is appropriate for the given application and the desired power input (AC versus DC, etc.). In addition, as is known, the circuitry can be separated and provided as two or more discrete components. Thus, the design of the controller 50 can be varied as desired.

As can be appreciated, the cover 10 can be configured to engage different shapes of LED arrays and can include built-in light shaping features (such as a reflector 25) and further includes fastener apertures 28 that allow the cover 10 to be securely mounted to a support surface (not shown). The cover 10 can further include a lens (not shown) if further light shaping control is desired.

The depicted cover 10 includes a connector 60 with a housing 61 that supports a plurality of terminals 62. The depicted connector 60 includes a side opening 60a that is configured to accept a mating connector that is inserted in a direction that could be considered parallel to the support surface (not shown). Of course, the support surface may not actually be flat and thus the insertion direction may actually be parallel to the actual supporting surface but such can still be considered parallel to the support surface. Alternatively, the connector 60 could include an opening that is configured to mate to a connector 60 in a direction perpendicular to a support surface. To secure the connector 60 to the cover 10, the terminals 62 can be soldered to pads 63 formed on the bottom side of the cover. The pads 63 can be connected to traces 46, 47 that are formed on the bottom side of the cover 10 and are electrically connected to the controller 50. Traces 44, 45 then connect the controller 50 to terminals 41, 42, which are supported by the cover 10. Preferably the terminals 41, 42 are respectively either soldered to the traces 44, 45. Thus, a first pair of traces extends between the connector 60 and the controller 50 and a second pair of traces extends between the controller 50 and the deflecting terminals 41, 42. As can be appreciated, additional features and components can be provided on the traces if discrete components are desired.

It should be noted that the cover 10 may further include an antenna 80 that is coupled to the controller 50, which can be configured to receive and transmit wireless signal by either including a transceiver (or being electrically coupled to a transceiver). Such a construction will enable the cover 10 to function in a wireless manner by receiving/transmitting wireless signals. The antenna 80 could be position on the bottom surface 11 or, if provided as depicted, then the antenna 80 could be position on a vertical wall 12 of the cover 10. As can be appreciated, the height of the vertical wall 12 can be used to determine the thickness of the cover assembly. Because of the vertical wall 12, the bottom surface 11 of the cover 10 can be spaced apart from a supporting surface.

It should be noted that the traces can be formed on the cover with an electroless plating. Thus, the cover can be formed using convention laser direct structuring (LDS) techniques. However, other methods of forming traces on plastic are also suitable and the ability to use LDS is not intended to be limiting.

The disclosure provided herein describes features in terms of preferred and exemplary embodiments thereof Numerous other embodiments, modifications and variations within the scope and spirit of the appended claims will occur to persons of ordinary skill in the art from a review of this disclosure.

We claim:

1. A cover assembly, comprising:
a cover with an aperture and a bottom surface configure to be spaced apart from a supporting surface;
a controller mounted on the bottom surface;
a first deflecting terminal and a second deflecting terminal, the first and second deflecting terminals supported by the housing;
a connector mounted to the cover, the connector including two terminals;
a first pair of traces extending between the two terminals and the controller; and
a second pair of traces extending between the controller and the deflecting terminals, the first and second pairs of traces configured so as to provide electrical power from the connector to the deflecting terminals via the controller.

2. The cover assembly of claim 1, wherein the cover includes a vertical wall that is configured to position the bottom surface above a supporting surface.

3. The cover assembly of claim 2, wherein the two terminals that are electrically connected to the first pair of traces and the deflecting terminals are electrically connected to the second pair of traces.

4. The cover assembly of claim 3, wherein the deflecting terminals are soldered to the cover.

5. The cover assembly of claim 4, wherein the connector has a side opening configured to receive a connector in a direction that is parallel to a supporting surface.

6. The cover assembly of claim 5, further comprising an LED array positioned in the aperture and supported by two retaining members.

7. The cover assembly of claim 6, wherein the controller is coupled to an antenna and is configured to receive wireless signals.

8. The cover assembly of claim 1, wherein the cover includes at least three surfaces configured to align an LED array with the aperture.
